(19) United States
(12) Patent Application Publication
(10) Pub. No.: US 2009/0172440 A1
(43) Pub. Date: Jul. 2, 2009

(54) COUPLED LOW POWER STATE ENTRY AND EXIT FOR LINKS AND MEMORY

(76) Inventors: Krishna Kant, Portland, OR (US); James W. Alexander, Hillsboro, OR (US)

Correspondence Address: INTEL CORPORATION;c/o CPA Global, P.O. BOX 52050, MINNEAPOLIS, MN, 55402, US

(21) Appl. No.: 11/967,873

(22) Filed: Dec. 31, 2007

(51) Int. Cl. G06F 1/32

(52) U.S. Cl. 713/323

(57) ABSTRACT

In some embodiments if a new request appears in a receive queue relating to a resource, and a controlled direction of the resource is in a low power state, a method starts an exit of the controlled direction after a delay. If receive direction of power control of the resource is in a low power state and preparation is being made to enter a low power state at the controlled direction, then the method decreases a watch and wait period that occurs prior to moving into the low power state at the controlled direction. Other embodiments are described and claimed.

### TECHNICAL FIELD

The inventions generally relate to coupled low power state entry and exit for links and memory.

### BACKGROUND

The basic (or uncoupled) power control of a resource (for example, a link, DRAM rank, processor core, etc.) typically proceeds in a manner that uses a low power state. When the resource is found to remain idle for some period of time, it is transitioned to a low power state where it stays either until the arrival of new requests for the resource or until some predetermined time expires.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a power state according to some embodiments of the inventions.

FIG. 2 illustrates a power state according to some embodiments of the inventions.

FIG. 3 illustrates simulation results according to some embodiments of the inventions.

FIG. 4 illustrates simulation results according to some embodiments of the inventions.

### DETAILED DESCRIPTION

Some embodiments of the inventions relate to coupled low power state entry and exit for links and memory.

In some embodiments, if a new request appears in a receive queue relating to a resource, and a controlled direction of the resource is in a low power state, a method starts an exit of the controlled direction after a delay. If another direction of power control of the resource is in a low power state and preparation is being made to enter a low power state at the controlled direction, then the method decreases a watch and wait period that occurs prior to moving into the low power state at the controlled direction.

In some embodiments, a coupling mechanism is included between the power control of two or more instances of the same resource in order to reduce the latency or improve efficiency of power control. The specific type of power control addressed here is the temporary transition of the resource in question to a low-power (and non-operational) mode when it is expected to remain idle for some time. The coupling applies whenever the resource instances are related in some deterministic or easily identifiable way (e.g., traffic on one resource instance implies traffic on another instance with a high probability and within certain amount of time).

A related patent application filed on even date herewith and titled “Hardware Proactive Implementation for Active Mode Power Control of Platform Resources” by Krisha Kant and Jimbo Alexander, Attorney Docket Number P26385, provides one example of power control algorithm in which some embodiments may be used, but many other embodiments exist and use of that type of power control is not necessary in some embodiments.

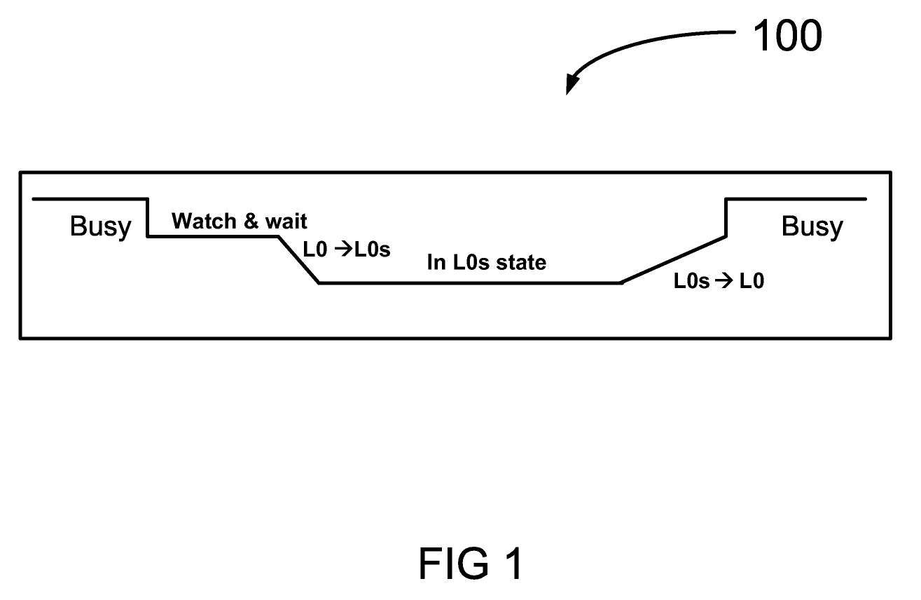

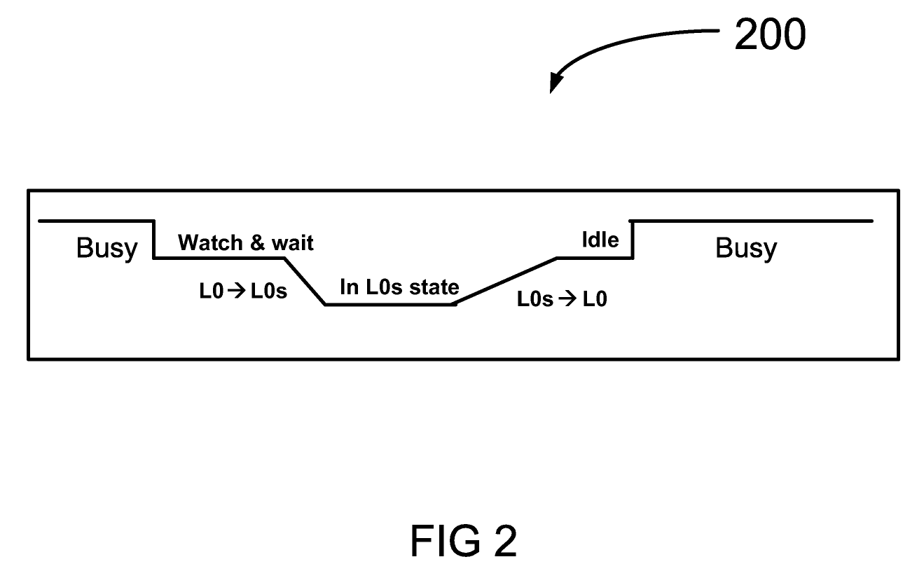

The basic (or uncoupled) power control of a resource proceeds as follows (e.g., link, DRAM rank, processor core, or some other type of resource). When the resource is found to remain idle for some period of time, it is transitioned to a low power state where it stays either until the arrival of new requests for the resource or until some predetermined timer expires. This is illustrated, for example, in FIG. 1 and FIG. 2. FIG. 1 and FIG. 2 use terminology appropriate for communication links, but it is noted that FIG. 1 and FIG. 2 can in some embodiments relate to other types of resources.

FIG. 1 illustrates a power state 100 of a resource according to some embodiments. In FIG. 1, L0 refers to normal power state and L0s refers to the first low power state. Like other resources, links can have multiple power states, but the discussion herein focuses on a single low power state control only. FIG. 1 illustrates the “reactive” exit wherein the link stays in L0s state until the traffic arrives and then starts the L0s→L0 transition process. Since the duration of the idle period can vary substantially, the L0→L0s transition is nearly always preceded by a “watch & wait” period which we also refer to as a runway. Runway control is an integral part of any power control algorithm.

FIG. 2 illustrates a power state 200 of a resource according to some embodiments. FIG. 2 illustrates an implementation of a proactive exit wherein the “gap” (or duration of idle period) is predicted and used for a proactive exit to L0 state.

As shown in FIG. 1 and FIG. 2, L0s entry and exit do not happen instantaneously; instead, they require a certain amount of time which can be rather large as compared with the typical time for which the resource is occupied by a transaction. A reactive exit as illustrated in FIG. 1 attempts to keep the resource in the low power state as long as possible. However, it guarantees that the arriving request will be delayed by the full exit time (or exit cost) of the resource. In contrast, the quality of the gap prediction is the key to the performance of a proactive implementation. If the predicted gap is too small, the process will transition to L0 state too soon and thus be unable to maximize power savings. On the other hand, if the predicted gap is too large, the link will be unable to move to L0 state by the time the new traffic arrives. Consequently, the new traffic will encounter additional delay and hence suboptimal performance.

Two key parameters of a power control implementation are: (a) Efficiency, or the fraction of time the process can keep the link in L0s state, and (b) Average additional delay encountered by the requests due to power control. These two parameters usually conflict, in that an improvement in efficiency generally implies an increase in latency and vice versa. In some embodiments, this conflict is addressed by exploiting the relationship between multiple resource instances. The precise details depend on the type of resource involved.

Some embodiments relate to an implementation in which a bidirectional link carries traffic to the memory, but many other implementations are possible. Some examples of a bidirectional link carrying traffic to memory include memory access via Quickpath, PCIE or FBD. In any case, each direction of the link is controlled by its transmit end. However, by examining the receive queue of the link in the opposite direction, certain decisions can be made.

In a coupled exit implementation, if a new request appears in the receive queue and the controlled (or transmit) direction is in low power state, the exit of the controlled direction is started after an appropriate delay.

In a coupled entry implementation, if the receive direction of the link is already in low power state and a preparation is being made to enter low power state on the transmit side, the runway is decreased (down to zero or some other smaller value).

The coupled exit implementation is motivated by the fact that every incoming request on a link will require sending a response out following the requested memory operation (read or write). Therefore, the “appropriate delay” D to schedule coupled exit, is given by:

D=max(memory_access_time−link_exit_cost, 0)

where the memory_access_time must be estimated as it can vary as a result of local memory traffic. We propose an exponential smoothing technique to estimate it. That is, if Tₙ is the running estimate of memory access time at nth step, and tₙ is the most recent actual access time, we update the running estimate as follows

Tₙ=(1−α)Tₙ₋₁+αtₙ

where α ε [0 . . . 1] is the smoothing constant which specifies how much weight a new sample gets. For efficient hardware implementation, α can be chosen as a negative power of 2. The computation then only involves integer add, subtract and shifts.

A major value of the coupled exit implementation is that it can reduce the exit latency impact significantly without hurting the efficiency of the power control implementation. If the link exit cost is small enough so that D will be almost always positive, the technique can wake up the other direction at the precise time needed.

The coupled entry implementation is motivated by the fact that the request-response scenario induces a strong correlation between the traffic on two sides of the link Thus, the fact that the other side is already in L0s state increases the chances that it is appropriate for this side to jump into L0s as well once it has handled all its residual traffic.

A major value of the coupled entry implementation is that it increases the efficiency of power control without significantly increasing the latency. Since the runway duration is related to the entry plus exit cost of the link, the coupled entry implementation can help significantly when entry and/or exit costs are high.

Similar ideas can be used in the context of CKE (clock enable) based power control of DRAM which gates off unnecessary logic. DRAM memory on a platform is divided up into physical DIMMs, each of which may be further divided up into “ranks”, with 2 or 4 ranks per DIMM. There are, in fact, two CKE power control modes—called fast and slow CKE, respectively. The fast CKE control can be done independently for each rank. The coupling between different resources (or ranks) is a result of the preferred order in which ranks are accessed. This order can be exploited to speculatively initiate CKE exit on the rank that we are most likely to go to next and enter CKE on the rank just finished.

Detailed simulations have been used to assess the value of the proposed technique for Quickpath and PCIE in the context of the proactive implementation called ESA (exponential smoothing algorithm) which is discussed in further detail in the related application mentioned previously herein.

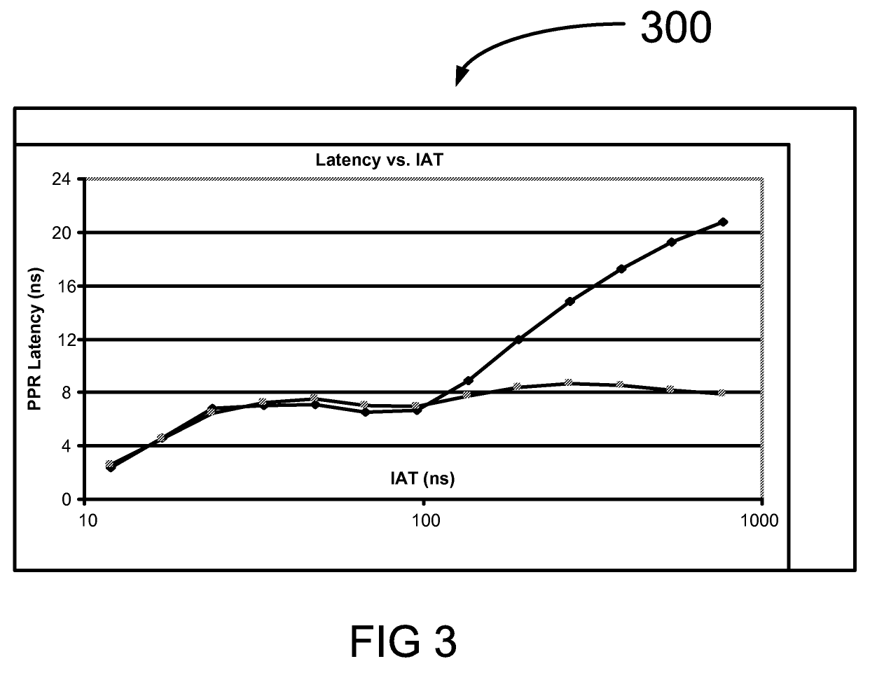

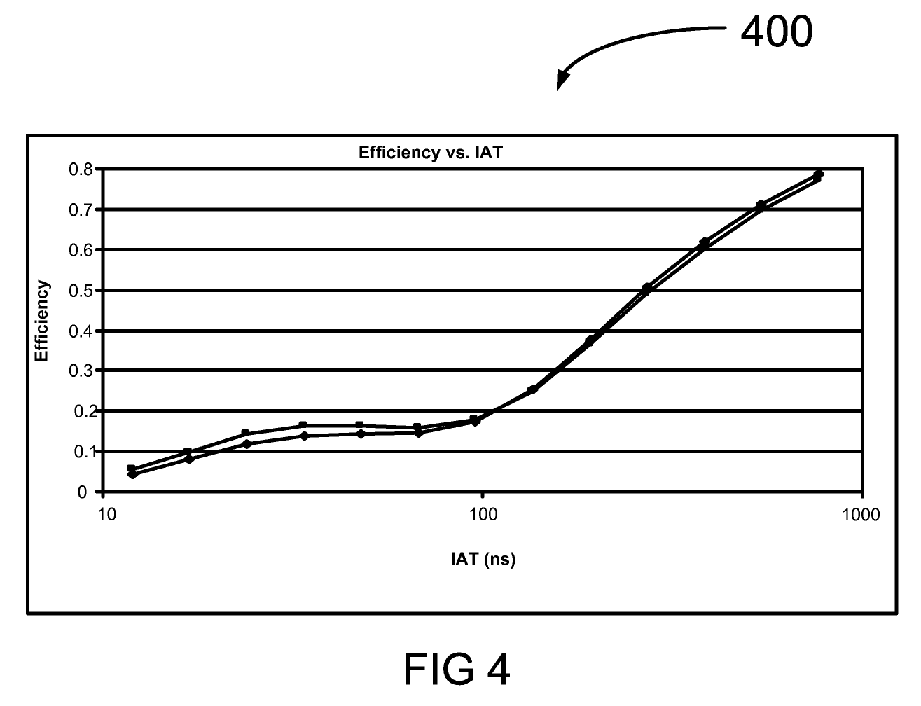

FIG. 3 and FIG. 4 illustrate simulation results 300 and 400 for 6.4 GT/sec Quickpath. The best estimates for the entry and exit costs for Quickpath are 10 ns and 25 ns respectively, so the total cost is about an order of magnitude larger than the typical link transmission time. This is where a proactive implementation such as ESA can provide a respectable power savings without adding excessive latencies to the memory access path. Of course, a reactive implementation can achieve higher power savings at the same link utilization level, but it will have a comparatively much larger latency impact.

The x-axis in both graphs 300 and 400 is the inter-arrival time (IAT) of requests in ns. An IAT of 10 corresponds to about 25% utilization for Quickpath (and hence 1000 ns corresponds to 0.25% utilization). The two graphs show the latency and efficiency of the coupled vs. uncoupled control. It is seen that the coupled control reduces the latency substantially at low utilizations (where there is significant chance for power control) without affecting the efficiency to any appreciable extent.

In some embodiments, relationships between multiple resource instances are exploited in order to improve latency without significantly affecting efficiency (via coupled exit) and improve efficiency without significantly worsening the latency (via coupled entry). The technique can be used with any power control implementation and applies to multiple resource types including links of various sorts, memory and CPU cores.

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
if a new request appears in a receive queue relating to a resource, and a controlled direction of the resource is in a low power state, starting an exit of the controlled direction after a delay; and
if receive direction of power control of the resource is in a low power state and preparation is being made to enter a low power state at the controlled direction, then decreasing a watch and wait period that occurs prior to moving into the low power state at the controlled direction.

2. The method of claim 1, wherein the resource is a link.

3. The method of claim 2, wherein the link is a link to memory.

4. The method of claim 2, wherein the link is a bidirectional link.

5. The method of claim 1, wherein the resource is a memory rank.

6. The method of claim 5, wherein the controlled direction and the receive queue relate to clock enable signals.

7. The method of claim 1, wherein the resource is a processor core.

8. The method of claim 1, wherein the watch and wait period is a runway between a normal power state and the low power state.

9. The method of claim 1, wherein the delay is related to an access time.

10. An apparatus comprising:
a controller to start an exit of a controlled direction of a resource after a delay if a new request appears in a receive queue relating to the resource, and if the controlled direction of the resource is in a low power state, and to decrease a wait and watch period that occurs prior to moving into the low power state at the controlled direction if the receive direction of power control of the resource is in a low power state and preparation is being made to enter a low power state at the controlled direction.

11. The apparatus of claim 10, wherein the resource is a link.

12. The apparatus of claim 11, wherein the link is a link to memory.

13. The apparatus of claim 11, wherein the link is a bidirectional link.

14. The apparatus of claim 10, wherein the resource is a memory rank.

15. The apparatus of claim 10, wherein the controlled direction and the receive queue relate to clock enable signals.

16. The apparatus of claim 10, wherein the resource is a processor core.

17. The apparatus of claim 10, wherein the watch and wait period is a runway between a normal power state and the low power state.

18. The apparatus of claim 10, wherein the delay is related to an access time.
